(19) United States
(12) Patent Application Publication
(10) Pub. No.: US 2002/0076260 A1
(43) Pub. Date: Jun. 20, 2002

(54) Adapter for a static mixer

(75) Inventor: Rolf Heusser, Winterthur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Chemtech AG, Winterthur (CH)

(21) Appl. No.: 09/992,846

(22) Filed: Nov. 14, 2001

(30) Foreign Application Priority Data
Nov. 29, 2000 (EP) 00811134.6

(51) Int. Cl. B01F 13/00; B01F 15/00

(52) U.S. Cl. 401/266; 366/349

(57) ABSTRACT

The adapter (3) is provided for a static mixer (1) to carry out a shaped dispensing of a viscid mixture from the mixer. The adapter is formed in the shape of a plastic injection-molded part such that it is mountable on a discharge orifice (11) of the mixer. It forms a passage with a variable cross-section with a wall (33), with the flow of the mixture being guidable though said passage to a slit-shaped outlet opening (4). The passage wall (33) is provided with linear cutting aids (40) on the outside which extend at least approximately parallel to the slit direction of the outlet opening (4). The passage wall can be cut through along these cutting aids so that a new, slit-shaped outlet opening (4a) is created which is shorter than the original outlet opening in the slit direction. The linear cutting aids are arranged such that the newly made outlet openings have pre-set cross-sectional areas.

The invention relates to an adapter for a static mixer in accordance with the preamble of claim 1 and to a discharge device having such an adapter.

EP-A-0 579 889 discloses a mixer with an adapter, called an attachment there. Two components from a double cartridge can be mixed to a viscid, largely homogeneous mass in the mixer. A shaped dispensing of the viscid mixture can be carried out with the adapter, which is mounted on, or pushed onto, a discharge orifice, that is the mass to be discharged can be given a certain shape by means of a suitably shaped outlet opening of the adapter. A plurality of shapes of the discharged beads can be generated by using different adapters, for example wedge-shaped beads with triangular outlet openings or strip-like flat beads with slit-shaped outlet apertures.

It is the object of the invention to provide an adapter for the manufacture of strip-like beads which easily allows the discharge of beads having different, but pre-settable widths by means of a preparation of the adapter. This object is satisfied by the adapter defined in claim 1.

The adapter is provided for a static mixer to carry out a shaped dispensing of a viscid mixture from the mixer. The adapter is formed in the shape of a plastic injection-moulded part such that it is mountable on a discharge orifice of the mixer. It forms a passage with a variable cross-section with a wall, with the flow of the mixture being guidable through said passage to a slit-shaped outlet opening. The passage wall is provided with linear cutting aids on the outside which extend at least approximately parallel to the slit direction of the outlet opening. The passage wall can be cut through along these cutting aids so that a new slit-shaped outlet opening is created which is shorter than the original outlet direction in the slit direction. The linear cutting aids are arranged such that the newly made outlet openings have pre-set cross-sectional areas.

The dependent claims 2 to 8 relate to advantageous embodiments of the adapter in accordance with the invention. A discharge device having an adapter in accordance with the invention is the subject matter of claim 9.

The invention is described below with reference to the drawings, in which are shown:

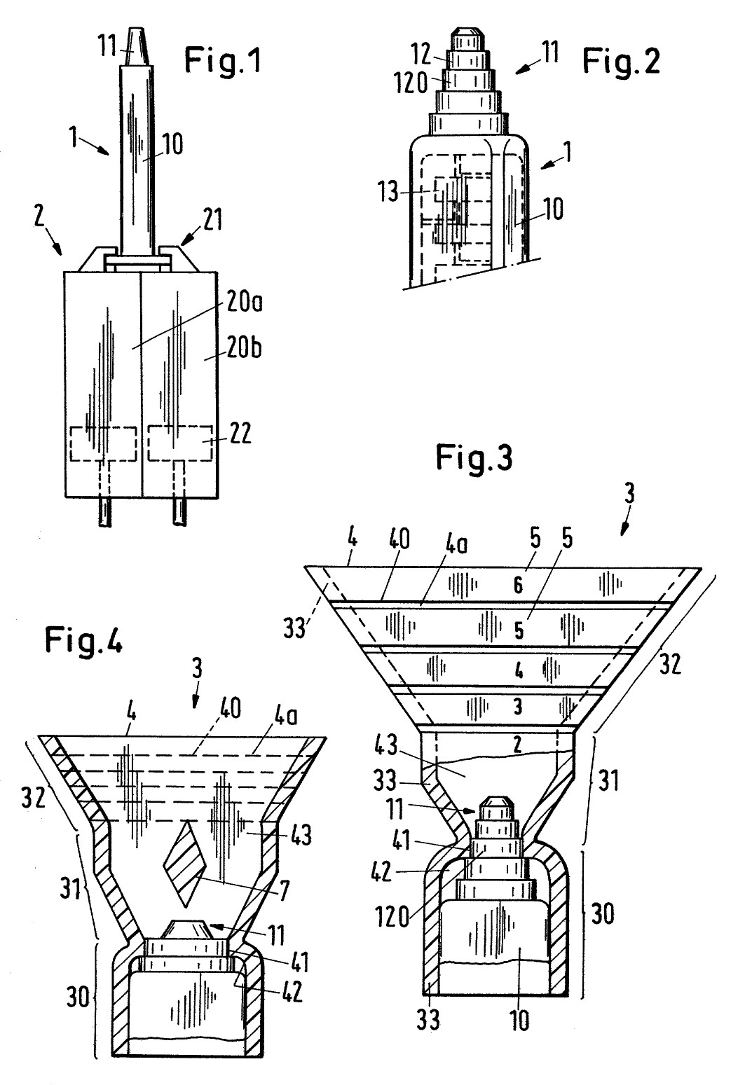

FIG. 1 a discharge device having a double cartridge and a static mixer;

FIG. 2 the tip and discharge orifice of the static mixer;

FIG. 3 an adapter in accordance with the invention which is mounted on the mixer tip;

FIG. 4 a second embodiment of the adapter in accordance with the invention;

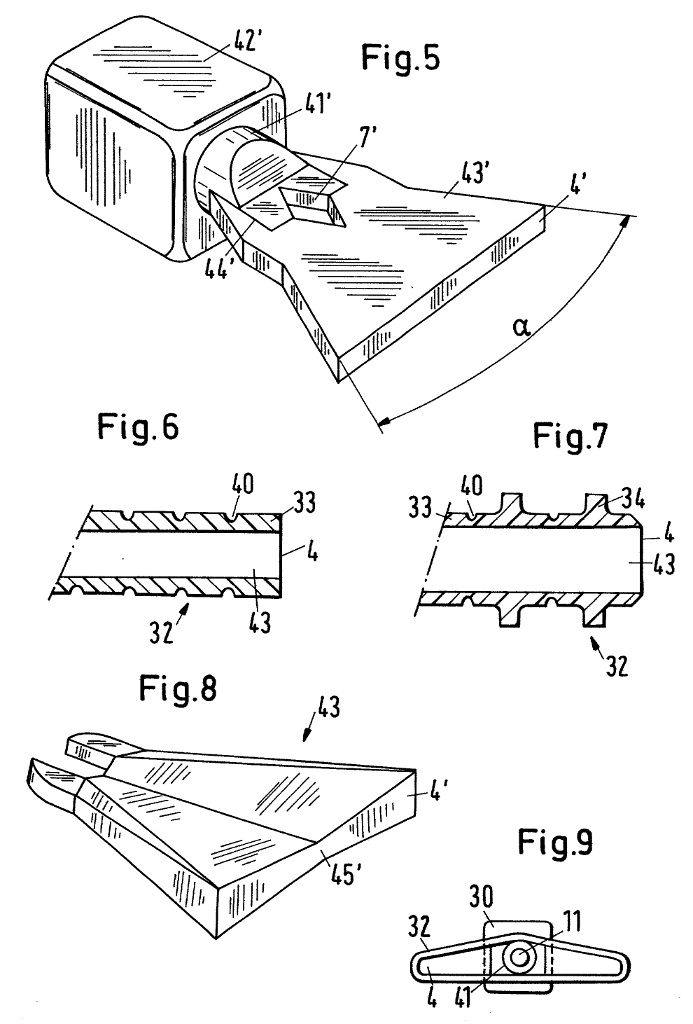

FIG. 5 an injection-moulding core for the adapter of FIG. 4;

FIG. 6 a longitudinal section through the adapter in accordance with the invention situated in the region of the outlet opening;

FIG. 7 a longitudinal section as in FIG. 6 for a variant form of the adapter;

FIG. 8 an injection-moulding core for a third embodiment of the adapter;

FIG. 9 a plan view of the outlet opening of a fourth embodiment; and

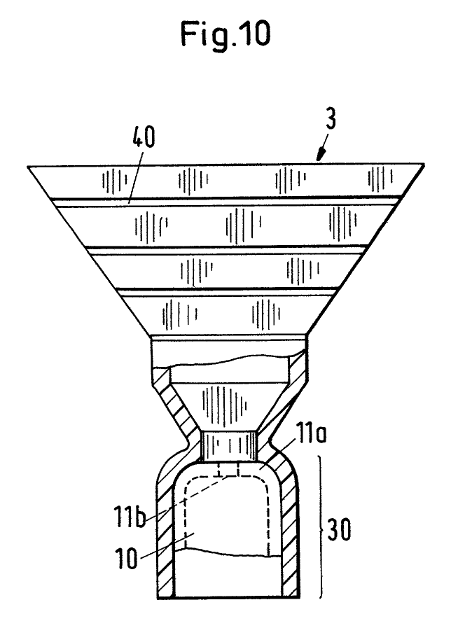

FIG. 10 a mixer tip having an adapter in which the tip is formed only as a discharge orifice.

The discharge device illustrated schematically in FIG. 1 consists of a static mixer 1 having a tube 10 and a tip 11 and of a double cartridge 2 having two containers 20a and 20b from which pasty components can be pressed into the mixer 1 by pistons 22 and mixed there. The mixer 1 is connected to the cartridge 2 by means of a bayonet fastening 21. (Different joints between the mixer 1 and the cartridge are also known.) The tip 11, which is shown in more detail in FIG. 2, has cylindrical segments 12, 120 arranged in a wedge shape and having stepped diameters. A mixer element 13 is located in the tube 10, which is a square tube. The tip 11 is the discharge orifice of the mixer 1 onto which an adapter 3 in accordance with the invention—see FIGS. 3 and 4—can be mounted.

The adapter 3 is made of a plastic in an injection-moulding process. Three regions arranged one after another can be distinguished: an attaching region 30, a transition region 31 and an outlet region 32. The adapter 3 forms a passage with a variable cross-section with a wall 33 and the flow of the mixed components is guided through this passage from the discharge orifice 11 of the mixer 1 to a slit-shaped outlet opening 4. A circular cylindrical through-section 41 is located in the attaching region 30 and is advantageously formed such that a segment 120 of the mixer tip 11 can be inserted into it in a tight-fitting manner. The wall 33 is formed in a complementary manner to the surface of the mixer tube 10 in the rear part of the attaching region 30. The dimensions of the attaching region 30 are selected such that the adapter 3 can be attached to the mixer 1 by being placed on it, with it being fixed in place in the example shown only due to static friction. A snap-in mechanism can also be provided between the attaching region 30 of the adapter 3 and the mixer tube 10 for a more effective fixing. A sealing of the adapter 3 to the rear can be made by means of a tight fit between the through-section 41 and the segment 120 and/or between the attaching region 30 and the mixer tube 10.

The passage wall 33 is provided with linear cutting aids 40 on the outside of the outlet region 32 which extend at least approximately parallel to the slit direction of the outlet opening 4. The passage wall 33 can be cut through along the cutting aids 40. When the front part is cut away, a new, slit-like outlet opening 4a is created which is shorter in the slit direction than the original outlet opening 4. The linear cutting aids 40 are positioned such that pre-set cross-sectional areas are obtained with the newly made outlet openings 4a.

The linear cutting aids 40 can simply be lines pressed onto the wall 33. However, these cutting aids 40 are advantageously formed as grooves.

The linear cutting aids 40 are advantageously provided with characterising markings 5 which allow a direct reading or a reading by code of how large the cross-sectional area of the newly made outlet opening 4a is. In the example of FIG. 3, the numerals 2 to 6, which are indicated as the markings 5, are proportional to the slit length of the outlet openings 4 or 4a.

FIG. 4 shows a second embodiment of the adapter 3. This is provided for a dispensing of beads which are wider in comparison with the adapter 3 of FIG. 3. The transition region 31 is provided with a flow divider 7 in this adapter 3, said flow divider 7 effecting the rapid transverse spread of the flow exiting from the discharge orifice 11.

FIG. 5 shows an injection-moulding core for the adapter 3 of FIG. 4, said core being assembled from two parts 42′ and 43′. The parts 42′ and 43′ correspond to the respective hollow spaces 42 and 43 in the adapters 3 of FIGS. 3 and 4. A recess 7′, which corresponds to the flow divider 7, is located at a common border 44′ of the two parts 42′ and 43f. The front side 4′ of the part 43′ corresponds to the slit-shaped outlet opening 4. The cylindrical flat piece 41′ corresponds to the through-section 41.

The outlet region 32 essentially has the shape of a trapezoid in a plane set by the transport direction of the mixture and the slit direction of the outlet opening 4, the non-parallel opposite sides of said trapezoid forming an angle a (see FIG. 5) which has a value in the range between 40° and 90°, preferably between 60° and 70°.

The original outlet opening 4 has a length in the slit direction which is 5 to 20 times greater than the width of the outlet opening; the original and the newly made outlet openings 4a are largely of the same size.

The front part of the outlet region 32 with the wall 33, the hollow space 43 and the outlet opening 4 is shown as a longitudinal section in the FIGS. 6 and 7. The grooves 40 are round flutes in a planar surface in FIG. 6. In the example of FIG. 7, the strips between the grooves 40 are reinforced by ribs 34.

The original outlet opening 4 and the newly made outlet openings 4a each have a largely rectangular slit shape in the adapters of FIGS. 3 and 4. These openings 4 and 4a respectively can also be triangular or pentagonal. Furthermore, a different slit shape with a variable width is also feasible, where the width tapers towards the centre. The front part 43′ of an injection-moulding core is illustrated in FIG. 8 for this embodiment. The reference numeral 45′ indicates the position of the narrowest point of the outlet opening 4, which corresponds to the area 4a′. In this embodiment, the flow resistance in the central zone of the outlet region 32 is somewhat increased. In a rectangular outlet opening 4, the flow speed in the central region is higher than in the side regions of the outlet region 32. A restriction of the flow in the central region due to the increased flow resistance can effect a homogenisation of the discharge in a suitable design.

A plan view of the outlet opening 4, which is approximately pentagonal (shape of a flat, isosceles triangle in which the two corner regions of the triangle base have been removed in a symmetrical manner) is shown for a fourth embodiment in FIG. 9. In addition to the outlet region 32, the attaching region 30, the through-section 41 and the mixer tip 11 can be seen in this illustration.

FIG. 10 shows a mixer tip 11a with an adapter 3 in which the discharge orifice is formed only in the shape of an outlet opening 11b. When mixers 1 are used with the adapter 3, tips 11 in accordance with FIG. 2 can be dispensed with.

1. An adapter (3) for a static mixer (1) to carry out a shaped dispensing of a viscid mixture from the mixer, which adapter is formed as a plastic injection-moulded part such that it is mountable on a discharge orifice (11) of the mixer and such that it forms a passage with a variable cross-section with a wall (33), with the flow of the mixture being guidable though said passage to a slit-shaped outlet opening (4), characterised in that the passage wall (33) is provided with linear cutting aids (40) on the outside which extend at least approximately parallel to the slit direction of the outlet opening (4) and along which the passage wall can be cut through so that a new, slit-shaped outlet opening (4a) is created which is shorter than the original outlet opening in the slit direction, with the linear cutting aids being arranged such that the newly made outlet openings have pre-set cross-sectional areas.

2. An adapter in accordance with claim 1, characterised in that the linear cutting aids (40) are grooves.

3. An adapter in accordance with claim 1 or claim 2 characterised in that the linear cutting aids (40) are provided with characterising markings (5) with which the information on how large the cross-sectional area of the newly made outlet opening (4a) is can be read off directly or by means of a code.

4. An adapter according to one of the claims 1 to 3, characterised in that three regions arranged after one another can be distinguished, namely an attaching region (30), a transition region (31) and an outlet region (32), with the linear cutting aids (40) being arranged in the outlet region (32), the mixture being guidable from the discharge orifice (11) of the mixer (1) to the outlet region (4) in the transition region (31) and the adapter being attachable to the mixer by being mounted in the attaching region (30).

5. An adapter in accordance with claim 4, characterised in that the outlet region (32) essentially has the shape of a trapezoid in a plane set by the transport direction of the mixture and the slit direction of the outlet opening (4), the non-parallel opposite sides of said trapezoid forming an angle (a) which has a value in the range between 40° and 90°, preferably between 60° and 70°.

6. An adapter in accordance with claim 4 of claim 5, characterised in that the original outlet opening (4) has a length in the slit direction which is 5 to 20 times greater than the width of the outlet region; and in that the original and the newly made outlet openings (4, 4a) have largely identically sized widths.

7. An adapter in accordance with one of the claims 4 to 6, characterised in that the original and the newly made outlet openings (4, 4a) each have a slit shape which is largely rectangular, triangular or pentagonal or which have a different slit shape with a variable width wherein the width tapers towards the centre.

8. An adapter in accordance with one of the claims 4 to 7, characterised in that a flow divider (7) is arranged in the transition region (31).

9. A discharge apparatus comprising a two-component cartridge (2), a static mixer (1) and an adapter (3) in accordance with one of the claims 1 to 8.
